(19) United States
(12) Patent Application Publication
(10) Pub. No.: US 2019/0224961 A1
(43) Pub. Date: Jul. 25, 2019

(54) METHOD OF CONTROLLING THE CLAMPING OF A PLATE IN A PRINTING PRESS

(71) Applicant: HEIDELBERGER DRUCKMASCHINEN AG, Heidelberg (DE)

(72) Inventors: KLAUS LULAY, BENSHEIM (DE); MATHIAS ZUBER, HELMSTADT-BARGEN (DE)

(21) Appl. No.: 16/251,884

(22) Filed: Jan. 18, 2019

(30) Foreign Application Priority Data
Jan. 23, 2018 (DE) 102018200996.1

(51) Int. Cl. B41F 27/12; B41F 27/00

(52) U.S. Cl. CPC B41F 27/1206; B41P 2227/30; B41F 27/125; B41F 27/005

(57) ABSTRACT

A method of controlling the clamping of a plate in a printing press includes clamping a plate in a first clamping device provided on a carriage, transporting the plate to a plate cylinder in a first direction by way of the carriage, and clamping the plate in a second clamping device provided on the plate cylinder. Then the carriage is driven backward in a second direction while the plate remains clamped in the first clamping device. If the plate is properly clamped in the plate cylinder clamps, the carriage is estopped from moving in the second direction. A control unit determines, based on the reaction of the carriage, whether or not the plate is securely clamped in the second clamping device.

### CROSS-REFERENCE TO RELATED APPLICATION

This application claims the priority, under 35 U.S.C. § 119, of German patent application DE 10 2018 200 996.1, filed Jan. 23, 2018; the prior application is herewith incorporated by reference in its entirety.

### BACKGROUND OF THE INVENTION

### Field of the Invention

The present invention lies in the printing field. More particularly, the invention pertains to a method for controlling the clamping of a plate in a printing press wherein a carriage having a first clamping device clamps a plate and transports it to a plate cylinder and the plate cylinder clamps the plate in a second clamping device.

German published patent application DE 10 2016 206 223 A1 discloses a plate changing device wherein a transport carriage transports the plate to the plate cylinder in a direction of transport, holding it by means of an integrated holding device in the process. The holding device is a clamping device with a first clamping surface disposed on a clamping die and a second clamping surface. The transport carriage pushes the leading edge of the plate into the clamping device of the plate cylinder. The plate is a flexographic printing plate for spot varnishing.

U.S. Pat. No. 5,320,041 and its corresponding European published patent application EP 0 555 782 A1 disclose a device for controlling plate engagement. An electrically conductive leading edge of the plate acts as a switch and register pins act as electrodes that are short-circuited by the leading edge of the plate when the plate is engaged with them.

A disadvantage of the latter prior art document is that the device is only suitable for plates that have an electrically conductive leading edge. The device is not suitable for plates that are not electrically conductive, for instance for the flexographic printing plate of the first-mentioned prior art document.

### BRIEF SUMMARY OF THE INVENTION

It is accordingly an object of the invention to provide a method of controlling the clamping of a plate in a printing press which overcomes the above-mentioned and other disadvantages of the heretofore-known devices and methods of this general type and which is suitable even if the printing plate is not electrically conductive.

With the foregoing and other objects in view there is provided, in accordance with the invention, a method of controlling the clamping of a plate in a printing press, the method comprising:

clamping a plate in a first clamping device provided on a carriage;

transporting the plate to a plate cylinder in a first direction by the carriage;

clamping the plate in a second clamping device disposed on the plate cylinder;

subsequently driving a backward movement of the carriage in a second direction opposite the first direction while the plate remains clamped in the first clamping device and determining, by a control unit on a basis of a reaction of the carriage, whether or not the plate is securely clamped in the second clamping device on the plate cylinder.

In other words, the above and other objects are attained by a method for controlling the clamping of a plate in a printing press comprising the steps of clamping a plate in a first clamping device provided on a carriage, transporting the plate to a plate cylinder in a first direction by means of the carriage, clamping the plate in a second clamping device provided on the plate cylinder, driving a backward movement of the carriage in a second direction while the plate remains clamped in the first clamping device, and detecting, by means of a control unit and based on a reaction of the carriage, whether or not the plate is securely clamped in the second clamping device.

An advantage of the method of the invention is that it is suitable for plates that are electrically conductive and for plates that are not electrically conductive.

Various further developments are possible, namely:
The plate may include a plastic material that is electrically non-conductive.
The plate may be a flexographic printing plate for printing or varnishing.
The reaction of the carriage may be detected by a sensor that is connected to the control unit.
The sensor may monitor the position of the carriage.
The sensor may operate without contact and may be oriented towards the carriage.

Other features which are considered as characteristic for the invention are set forth in the appended claims.

Although the invention is illustrated and described herein as embodied in a method for controlling the clamping of a plate in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an overall side view of a printing press having a plate changing device; and

FIGS. 2 to 4 are partial side views of a plate changing device, illustrating a sequence of steps that are carried out by the plate changing device.

### DETAILED DESCRIPTION OF THE INVENTION

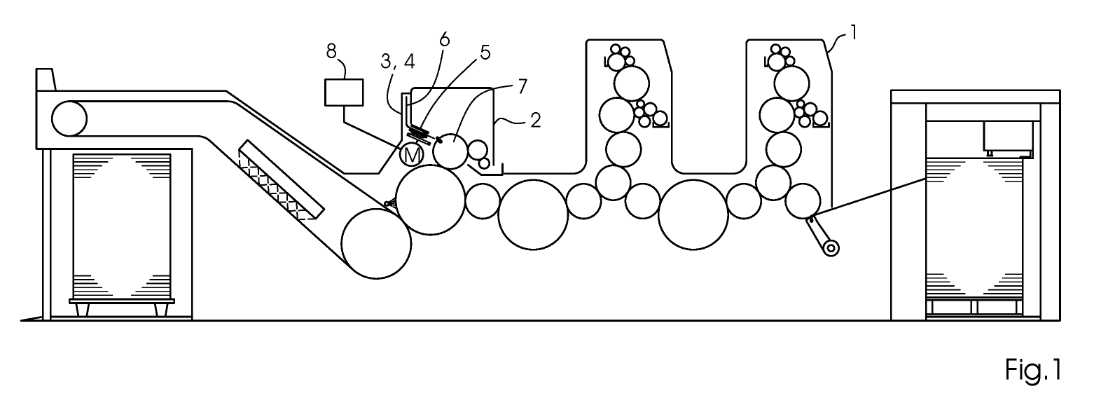

Referring now to the figures of the drawing in detail and first, particularly, to FIG. 1 thereof, there is shown a printing press 1 for printing on sheets in a lithographic offset printing process. The printing press 1 comprises a varnishing unit 2 with a plate changing device 3 that is automated.

The plate changing device 3 comprises a vertical feeding shaft 4. The plate changing device 3 further comprises a carriage 5 for transporting the plate 6 from the feeding shaft 4 to a plate cylinder 7.

The plate 6 includes an electrically non-conductive material such as plastic. The plate 6 is a flexographic printing plate for spot varnishing.

The carriage 5 is driven by a motor M, which is controlled by an electronic control unit 8, for instance a computer.

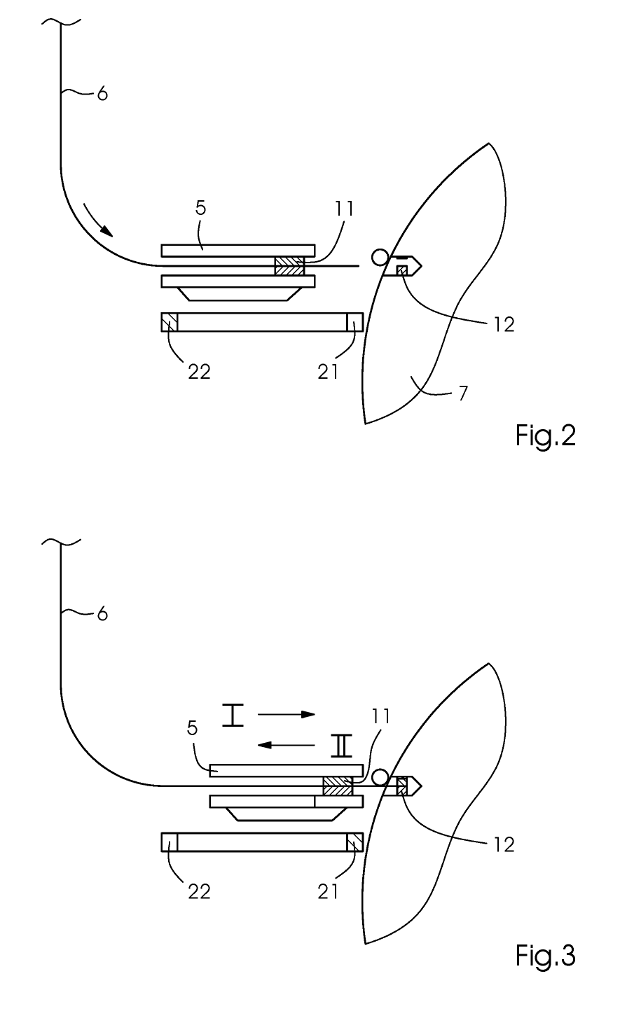

FIG. 2 shows that the carriage 5 has a first clamping device 11 and the plate cylinder 7 has a second clamping device 12. Every clamping device 11, 12 has two clamping jaws for clampingly holding the plate 6.

A monitoring device including a first sensor 21 and a second sensor 22 is disposed below the carriage 5. The first sensor 21 detects the presence of the leading end of the carriage 5 and the second sensor 22 detects the presence of the trailing end of the carriage 5. The first sensor 21 is a contact-free sensor, for instance an optical sensor. It is used as a stop position sensor. The second sensor 22 and the first sensor 21 may be of identical construction.

In the feeding shaft 4, the carriage 5 grips the plate 6 close to its leading edge. Holding the plate 6 in the first clamping device 11, the carriage 5 then moves out of the vertical position into an illustrated horizontal position along a transport path. The plate cylinder 7 is in an angular position in which the second clamping device 12 faces the carriage. The second clamping device 12 is open.

Further steps of the method are shown in FIG. 3. As it continues to hold the plate 6, the carriage 5 moves in a first direction I until the first sensor 21 signals to the control unit 8 that the carriage 5 has reached the first sensor 21. The actuation of the first sensor 21 is indicated by its hatching in the drawing. The first direction I is directed towards the plate cylinder 7. When it reaches the first sensor 21, the leading edge of the plate 6 is located in the second clamping device 12, which is then closed.

To check whether the second clamping device 12 has gripped the plate 6 correctly, the motor M adjusts or attempts to adjust the carriage 5 into a second direction II. During the adjustment or adjustment attempt in the second direction II, both clamping devices 11, 12 are closed.

The second direction II is the opposite direction to the first direction I. The two adjustments in directions I and II are linear adjustments along the same guide element, for instance a pair of rails. In both adjustments, the carriage 5 rolls or slides in a horizontal direction. In the present description, the vertical and horizontal directions are understood to include substantially vertical and substantially horizontal directions.

If the second clamping device 12 is closed in the correct way when the attempt is made to adjust the carriage 5 in the second direction II and if the plate 6 is in the correct position between the clamping jaws of the second clamping device 12, the second clamping device 12 will hold the carriage 5 via the plate 6, effectively preventing the carriage 5 from moving in the second direction II. Since the carriage 5 does not move out of the range of vision of the first sensor 21, the control unit 8 knows that the second clamping device 12 operates correctly because it is firmly closed and is clamping the plate 6.

A malfunctioning of the first clamping device may be ruled out because mechanical means such as springs ensure that the first clamping device 11 is firmly closed, preventing the plate 6 from sliding or getting skewed in the clamping device 11. In contrast to the first clamping device 11, for constructional reasons, malfunctions of the second clamping device 12 are more difficult to rule out solely by mechanical means.

If, upon the adjustment of the carriage 5 in the second direction II, the second clamping device 12 has not been closed correctly or if the plate 6 is not in the correct position in the second clamping device 12, the carriage 5 is free to move in the second direction II and out of the range of vision of the first sensor 21. This triggers a signal to the control unit 8.

This is the case, for instance, if the carriage 5 is moved into the second direction II while the leading edge of the plate 6 has slipped between the clamping jaws of the clamping device 12 or has even slipped out of the clamping jaws. Another example of a malfunction is that the leading edge of the plate 6 has not been introduced into the second clamping device 12 at all during the movement in the first direction I and that the clamping device was empty when it closed.

Once the control unit 8 has received a signal from the first sensor 21 that the carriage 5 has moved into the second direction II, the control unit 8 will interpret this signal as a malfunctioning of the second clamping device 12. Then the control unit 8 interrupts the automated plate clamping program sequence and emits an optical or acoustic signal to inform the operator of the malfunction.

The “attempt to pull” described above to check whether the plate 6 is or is not correctly clamped on the plate cylinder 7 takes approximately one second.

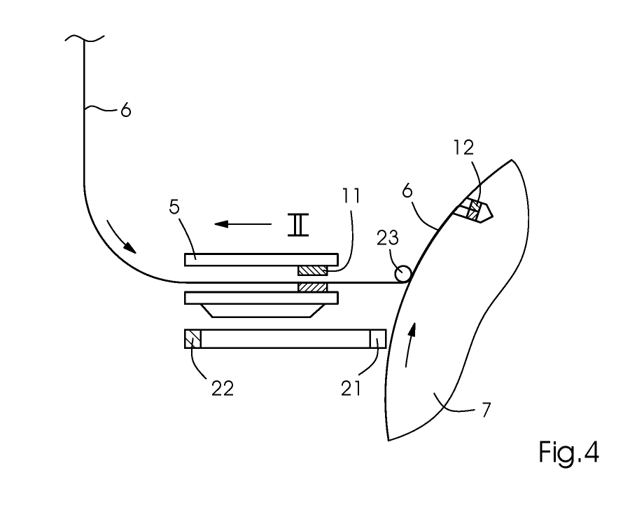

FIG. 4 illustrates further steps of the method 12 to be taken after the steps shown in FIG. 3 if the second clamping device 12 is functioning correctly. At first, the first clamping device 11 opens. Then the carriage 5 moves into the second direction II until it reaches its rear stop position, which is detected by the second sensor 22 and signaled to the control unit 8.

When the carriage 5 moves backward, the first clamping device 11 remains open, allowing the plate 6 to slide through. While the carriage 5 moves back or once the carriage 5 has moved back, the plate cylinder 7 is rotated into the direction indicated by the arrow while the second clamping device 12 clamping the plate 6 remains closed. As a result, the rotating plate cylinder 7 pulls the plate 6 out of the plate changing device 3 and out of the carriage 5 thereof, allowing the plate to wrap around the plate cylinder 7. A pressure roller 23 is provided to assist in wrapping the plate 6 around the plate cylinder 7.

### SUMMARY OF REFERENCE SYMBOLS

1 printing press

2 varnishing unit

3 plate changing device

4 feeding shaft

5 carriage

6 plate

7 plate cylinder

8 control unit

11 first clamping device

12 second clamping device

21 first sensor

22 second sensor

23 pressure roller

M motor

I first direction

II second direction

1. A method of controlling the clamping of a plate in a printing press, the method comprising:
clamping a plate in a first clamping device provided on a carriage;
transporting the plate to a plate cylinder in a first direction by the carriage;
clamping the plate in a second clamping device disposed on the plate cylinder;
subsequently driving a backward movement of the carriage in a second direction opposite the first direction while the plate remains clamped in the first clamping device and determining, by a control unit on a basis of a reaction of the carriage, whether or not the plate is securely clamped in the second clamping device on the plate cylinder.

2. The method according to claim 1, wherein the plate includes a plastic material that is an electrically non-conductive.

3. The method according to claim 1, wherein the plate is a flexographic printing plate for printing or varnishing.

4. The method according to claim 1, which comprises detecting the reaction of the carriage by a sensor connected to the control unit.

5. The method according to claim 4, which comprises monitoring with the sensor a position of the carriage.

6. The method according to claim 4, wherein the sensor is a contactlessly operating sensor oriented towards the carriage.
